(19) United States
(12) Patent Application Publication
(10) Pub. No.: US 2020/0208591 A1
(43) Pub. Date: Jul. 2, 2020

(54) PISTON OF INTERNAL COMBUSTION ENGINE

(71) Applicant: HITACHI AUTOMOTIVE SYSTEMS, LTD., Hitachinaka-shi, Ibaraki (JP)

(72) Inventor: Yuto HIGASA, Hadano-shi, Kanagawa (JP)

(73) Assignee: HITACHI AUTOMOTIVE SYSTEMS, LTD., Hitachinaka-shi, Ibaraki (JP)

(21) Appl. No.: 16/615,070

(22) PCT Filed: May 11, 2018
(86) PCT No.: PCT/JP2018/018272

§ 371 Date: Nov. 19, 2019

(30) Foreign Application Priority Data
May 25, 2017 (JP) 2017-103296

(51) Int. Cl. F02F 3/28; F02F 3/10; F16J 1/00

(52) U.S. Cl. CPC F02F 3/28; F16J 1/005; F02F 3/105

(57) ABSTRACT

The present invention provides a piston of an internal combustion engine capable of reducing a deformation amount of a piston head. A piston of an internal combustion engine includes a piston head, a pair of piston pin boss portions, a pair of skirt portions, and four apron portions connecting each of the pair of piston pin boss portions and each of the pair of skirt portions. Each of the four apron portions includes a bent portion, a boss portion-side portion positioned on one side where the pair of piston pin boss portions is located with respect to the bent portion, and a skirt portion-side portion positioned on an opposite side from the pair of piston pin boss portions with respect to the bent portion. A distance between an axis perpendicular to both an axis of a cylinder of the internal combustion engine and an axis of a piston hole and the boss portion-side portion is increasing according to an increase in a distance from the axis of the piston pin hole.

### TECHNICAL FIELD

The present invention relates to a piston of an internal combustion engine.

### BACKGROUND ART

Conventionally, there has been known a piston of an internal combustion engine including a piston head, a pair of piston pin boss portions, a pair of skirt portions, and four apron portions connecting the piston pin boss portions and the skirt portions. For example, in a piston disclosed in PTL 1, each of four apron portions includes a bent portion, a boss portion-side portion located on the piston pin boss portion side with respect to the bent portion, and a skirt portion-side portion located on the skirt portion side with respect to the bent portion.

### CITATION LIST

### Patent Literature

[PTL 1] Japanese Patent Application Public Disclosure No. 2015-132248

### SUMMARY OF INVENTION

### Technical Problem

The conventional piston has left room for a reduction in a deformation amount around a central portion of the piston head subjected to an external force.

### Solution to Problem

In a piston of an internal combustion engine according to one aspect of the present invention, preferably, a distance between an axis perpendicular to both an axis of a cylinder of the internal combustion engine and an axis of a piston pin hole and a boss portions-side portion is increasing according to an increase in a distance from the axis of the piston pin hole.

Therefore, the above-described distance is reducing and a distance between boss portion-side portions opposed to each other across the above-described perpendicular axis is reducing according to a reduction in a distance from a piston pin boss portion. As a result, the deformation amount can be reduced around the central portion of the piston head.

### BRIEF DESCRIPTION OF DRAWINGS

FIG. 1 schematically illustrates a cross section of a part of an engine cut along a plane passing through an axis of one cylinder according to a first embodiment.

FIG. 2 is a perspective view of one of two portions of a piston cut along a plane including a first axis and extending perpendicularly to a second axis according to the first embodiment.

FIG. 3 is a perspective view of the other of the two portions of the piston cut along the plane including the first axis and extending perpendicularly to the second axis according to the first embodiment.

FIG. 4 illustrates the above-described one portion of the piston according to the first embodiment as viewed from an opposite side from a piston crown surface.

FIG. 5 illustrates a quarter of a cross section passing through the second axis and extending perpendicularly to the first axis of the piston according to the first embodiment.

FIG. 6 illustrates a cross section taken along a line VI-VI in FIG. 4.

FIG. 7 illustrates a cross section in parallel with the first axis of a piston according to a second embodiment, which corresponds to FIG. 6.

FIG. 8 illustrates a half of a cross section passing through the second axis and extending perpendicularly to the first axis of a piston according to a third embodiment.

### DESCRIPTION OF EMBODIMENTS

In the following description, embodiments for implementing the present invention will be described with reference to the drawings.

### First Embodiment

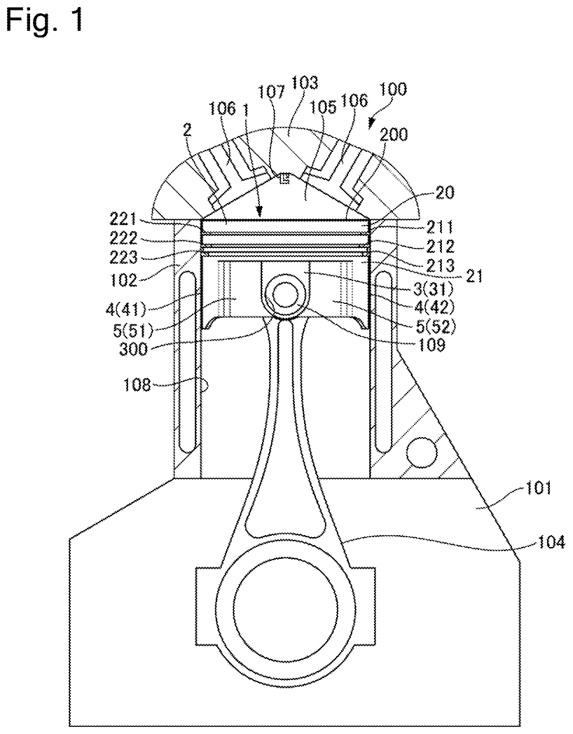

First, a configuration will be described. An internal combustion engine (an engine) 100 illustrated in FIG. 1 is a four-stroke gasoline engine, and is used as a source of a force driving a vehicle such as an automobile. The engine 100 includes a piston 1, a cylinder block 101, a cylinder head 103, a connecting rod (a connection rod) 104, a combustion chamber 105, valves 106, and an ignition device 107. A crankshaft, which is an output shaft of the engine, is rotatably mounted on the cylinder block 101. The cylinder block 101 includes a cylindrical cylinder sleeve (a cylinder liner) 102. An inner peripheral side of the cylinder liner 102 functions as an inner wall of a cylinder (a cylinder bore) 108. The piston 1 is reciprocatably contained inside the cylinder 108. The cylinder head 103 is mounted on the cylinder block 101 so as to cover an opening of the cylinder 108. As illustrated in FIG. 1, the combustion chamber 105 is defined between the piston 1 and the cylinder head 103 when the piston 1 is located at a top dead center. The valves 106, a nozzle for injecting fuel, and the ignition device 107 are mounted on the cylinder head 103. The valves 106 includes two intake valves and two exhaust valves.

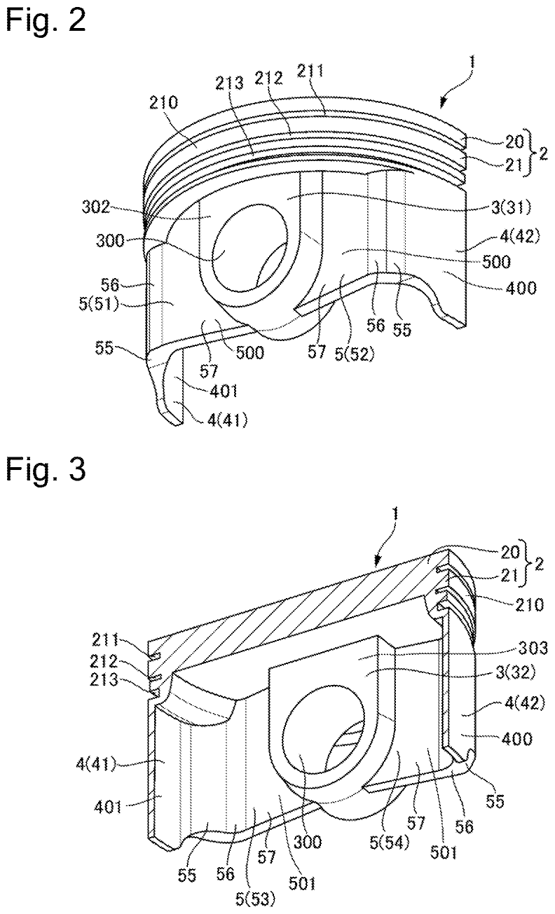

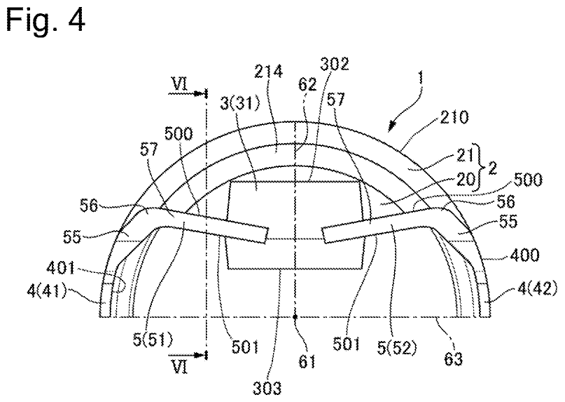

The piston 1 is cast as one member from aluminum alloy (for example, aluminum Al-silicon Si AC8A). The main material of the piston 1 is not limited to aluminum and may be, for example, magnesium or iron. As illustrated in FIGS. 2 to 4, the piston 1 has a bottomed cylindrical shape, and integrally includes a piston head (a crown portion) 2, piston pin boss portions 3, skirt portions 4, and apron portions 5. The piston head 2 integrally includes a crown surface portion 20 and a land portion 21. Cross section of the piston head 2 (the crown surface portion 20) cut along a plane perpendicular to a movement direction of the piston 1 inside the cylinder 108 is generally circular (for example, elliptic under a low temperature and becomes more circular under a high temperature). An axis passing through a center of this circle (ellipse) and extending along the above-described movement direction (in parallel with the above-described movement direction) will be referred to as a first axis 61 of the piston 1. Hereinafter, a plurality of axes including the first axis 61 will be defined as necessary, and a direction in which each of the axes extends will be referred to as an axial direction. The crown surface portion 20 is located on one side of the piston head 2 in a first axial direction. A piston crown surface (a top surface) 200 is located on one side of the crown surface portion 20 in the first axial direction. The piston crown surface 200 faces the combustion chamber 105.

The land portion 21 extends from an outer peripheral side of the crown surface portion 20 to the other side in the first axial direction. Three annular piston ring grooves 211, 212, and 213 are provided on an outer peripheral surface 210 of the land portion 21. Piston rings 221, 222, and 223 are set in the ring grooves 211, 212, and 213, respectively. A diameter of an inner peripheral surface 214 of the land portion 21 (a distance from the first axis 61) is gradually increasing from the one side toward the other side in the first axial direction. The piston pin boss portions 3, the skirt portions 4, and the apron portions 5 are connected to an opposite side of the piston head 2 from the piston crown surface 200 in the first axial direction, and extend from the piston head 2 to the other side in the first axial direction. The piston pin boss portions 3, the skirt portions 4, and the apron portions 5 are hollow on inner peripheral sides thereof.

A pair of piston pin boss portions 3 is provided on both sides in a radial direction of the piston 1 around the first axis 61 (hereinafter simply referred to as a radial direction). The piston pin boss portions 3 each include a first piston pin boss portion 31 and a second piston pin boss portion 32. Each of the piston pin boss portions 3 includes a piston pin hole 300. The piston pin hole 300 extends in the radial direction of the piston 1 while penetrating through the piston pin boss portion 3. An end portion of a piston pin 109 is inserted in the piston pin hole 300. The piston 1 is coupled with one end side (a small end portion) of the connecting rod 104 via the piston pin 109. The other end side (a large end portion) of the connecting rod 104 is coupled with the crankshaft. The piston pin hole 300 is cylindrical. Cross section of the piston pin hole 300 cut along a plane perpendicular to a longitudinal direction of the piston pin hole 300 is generally circular. An axis passing through a center of this circle and extending along the longitudinal direction of the piston pin hole 300 (an axis of the piston pin hole 300) will be referred to as a second axis 62 of the piston 1. Further, an axis perpendicular to both the first axis 61 and the second axis 62 will be referred to as a third axis 63 of the piston 1. Each of the piston pin boss portions 3 has a cylindrical shape surrounding the piston pin hole 300. The piston pin boss portion 3 extends in the first axial direction to be connected to the crown surface portion 20 of the piston head 2 on the one side of the second axis 62 in the first axial direction. The piston pin boss portion 3 is semi-cylindrical with an axis thereof extending along the piston pin hole 300 on the other side of the second axis 62 in the first axial direction. End portions 302 and 303 of the piston pin boss portion 3 in a second axial direction are shaped as flat surfaces perpendicular to the second axis 62.

A pair of skirt portions 4 is provided on the both sides in the radial direction of the piston 1. The skirt portions 4 each include a first skirt portion 41 and a second skirt portion 42. Each of the skirt portions 4 is located between the piston pin boss portions 31 and 32 in a direction around the first axis 61 of the piston 1 (hereinafter simply referred to as a circumferential direction), and is located on both sides of the piston pin boss portion 3 in a third axial direction. The skirt portion 4 includes an outer peripheral surface 400 and an inner peripheral surface 401 on an outer side and an inner side thereof in the radial direction. The outer peripheral surface 400 is curved along an inner peripheral surface of the cylinder 108. Both the surfaces 400 and 401 are generally in parallel with each other, and extend in the first axial direction. The outer peripheral surface 400 is wider than (extends farther away from the third axis 63 than) the inner peripheral surface 401 in the second axial direction.

Four apron portions 5 are provided, and the apron portions 5 include a first apron portion 51, a second apron portion 52, a third apron portion 53, and a fourth apron portion 54. Each of the apron portions 5 connects (couples) the piston pin boss portion 3 and the skirt portion 4 to each other in the circumferential direction of the piston 1 (in the second axial direction and the third axial direction). The first apron portion 51 connects the first piston pin boss portion 31 and the first skirt portion 41 to each other. The second apron portion 52 connects the first piston pin boss portion 31 and the second skirt portion 42 to each other. The third apron portion 53 connects the second piston pin boss portion 32 and the first skirt portion 41 to each other. The fourth apron portion 54 connects the second piston pin boss portion 32 and the second skirt portion 42 to each other. The apron portion 5 includes an outer peripheral surface 500 and an inner peripheral surface 501 on an outer side and an inner side thereof in the radial direction. A part of the skirt portion 4 protrudes and extends beyond the apron portion 5 toward the other side in the first axial direction.

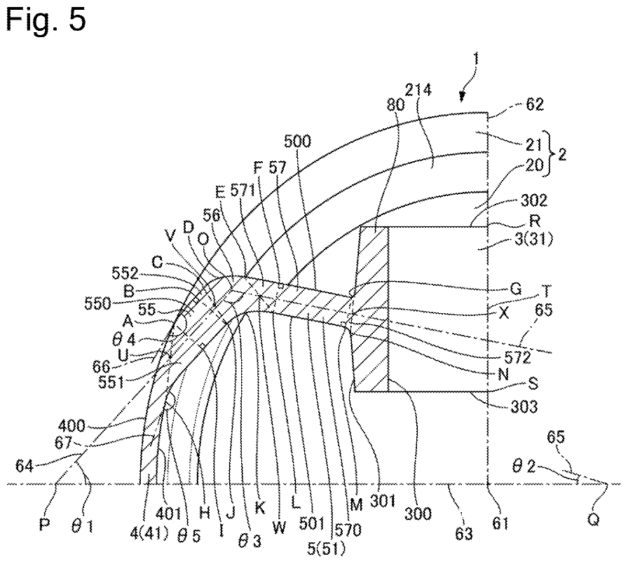

FIG. 5 illustrates a cross section 80 of the piston 1 that passes through the second axis 62 and extends perpendicularly to the first axis 61. In the following description, the piston 1 will be described with reference to the cross section 80. Each of the apron portions 5 includes a skirt portion-side portion 55, a bent portion 56, and a boss portion-side portion 57. The bent portion 56 is located around an intermediate position of the apron portion 5 in the circumferential direction of the piston 1 (the third axial direction). The skirt portion-side portion 55 is located on the skirt portion 4 side with respect to the bent portion 56 in the circumferential direction of the piston 1 (the third axial direction), and connects (couples) the bent portion 56 and the skirt portion 4 to each other. The skirt portion-side portion 55 is a portion that extends in the circumferential direction of the piston 1 similarly to the skirt portion 4, and, along therewith, is bent inward in the radial direction of the piston 1 with respect to the skirt portion 4. The skirt portion-side portion 55 overlaps the land portion 21 of the piston head 2 as viewed from the first axial direction. The skirt portion-side portion 55 is connected to the land portion 21 on the one side in the first axial direction. The boss portion-side portion 57 is located on the piston pin boss portion 3 side with respect to the bent portion 56 in the circumferential direction of the piston 1 (the third axial direction), and connects (couples) the bent portion 56 and the piston pin boss portion 3 to each other. Most of the boss portion-side portion 57 overlaps the crown surface portion 20 of the piston head 2 as viewed from the first axial direction. Most of the boss portion-side portion 57 is connected to the crown surface portion 20 on the one side in the first axial direction.

The skirt portion-side portion 55 includes a main body portion 550 constant in thickness and two end portions 551 and 552 varying in thickness in the circumferential direction of the piston 1. The end portion 551 on the skirt portion 4 side is a transition portion from the main body portion 550 to the skirt portion 4. The end portion 552 on the bent portion 56 side is a transition portion from the main body portion 550 to the bent portion 56. The outer peripheral surface 500 of the skirt portion-side portion 55 is shaped as a generally flat surface extending in the first axial direction, and extends between a point A and a point C in the circumferential direction of the piston 1. The point A corresponds to a boundary line between the outer peripheral surface 400 of the skirt portion 4 and the outer peripheral surface 500 of the skirt portion-side portion 55. The point C corresponds to a boundary line between the outer peripheral surface 500 of the skirt portion-side portion 55 and the outer peripheral surface 500 of the bent portion 56. The inner peripheral surface 501 of the skirt portion-side portion 55 is shaped as a generally flat surface extending in the first axial direction, and extends between a point H and a point J in the circumferential direction of the piston 1. The point H corresponds to a boundary line between the inner peripheral surface 401 of the skirt portion 4 and the inner peripheral surface 501 of the skirt portion-side portion 55. The point J corresponds to a boundary line between the inner peripheral surface 501 of the skirt portion-side portion 55 and the inner peripheral surface 501 of the bent portion 56. The outer peripheral surface 500 and the inner peripheral surface 501 of the skirt portion-side portion 55 are substantially in parallel with each other. A distance from the third axis 63 to the outer peripheral surface 500 of the skirt portion-side portion 55 in the second axial direction is reducing from the point C toward the point A (according to an increase in a distance from the second axis 62). A distance from the third axis 63 to the inner peripheral surface 501 of the skirt portion-side portion 55 in the second axial direction (a distance between the skirt portion-side portion 55 and the third axis 63) is reducing from the point J toward the point H (according to an increase in the distance from the second axis 62). A point I on the inner peripheral surface 501 of the skirt portion-side portion 55 is an intersection point between a perpendicular line drawn from the point A toward the inner peripheral surface 501, and the inner peripheral surface 501. A point B on the outer peripheral surface 500 of the skirt portion-side portion 55 is an intersection point between a perpendicular line drawn from the point J toward the outer peripheral surface 500, and the outer peripheral surface 500. The end portion 551 is a generally right triangle range surrounded by the point A, the point I, and the point H. A line segment connecting the point A and the point H to each other corresponds to a boundary surface between the skirt portion 4 and the skirt portion-side portion 55 (the end portion 551). The end portion 552 is a generally right triangle range surrounded by the point J, the point B, and the point C. A line segment connecting the point J and the point C to each other corresponds to a boundary surface between the skirt portion-side portion 55 (the end portion 552) and the end portion 56.

The bent portion 56 is a transition region from one to the other of the skirt portion-side portion 55 and the boss portion-side portion 57 in the circumferential direction of the piston 1. The outer peripheral surface 500 of the bent portion 56 has a curved shape convexed outward in the radial direction of the piston 1, and extends in the first axial direction. The outer peripheral surface 500 of the bent portion 56 extends between the point C and a point E in the circumferential direction of the piston 1. A curvature is maximized at a point D. The inner peripheral surface 501 of the bent portion 56 has a curved shape convexed outward in the radial direction of the piston 1, and extends in the first axial direction. The inner peripheral surface 501 of the bent portion 56 extends between the point J and a point L in the circumferential direction of the piston 1. A curvature is maximized at a point K.

The boss portion-side portion 57 includes a main body portion 570 constant in thickness and two end portions 571 and 572 varying in thickness in the circumferential direction of the piston 1. The end portion 571 on the bent portion 56 side is a transition portion from the main body portion 570 to the bent portion 56. The end portion 572 on the piston pin boss portion 3 side is a transition portion from the main body portion 570 to the piston pin boss portion 3. The outer peripheral surface 500 of the boss portion-side portion 57 is shaped as a flat surface extending in the first axial direction, and extends between the point E and a point G in the circumferential direction of the piston 1. The point E corresponds to a boundary line between the outer peripheral surface 500 of the bent portion 56 and the outer peripheral surface 500 of the boss portion-side portion 57. The point G corresponds to a boundary line between the outer peripheral surface 500 of the boss portion-side portion 57 and the outer peripheral surface 301 of the piston pin boss portion 3. The inner peripheral surface 501 of the boss portion-side portion 57 is shaped as a generally flat surface extending in the first axial direction, and extends between the point L and a point N in the circumferential direction of the piston 1. The point L corresponds to a boundary line between the inner peripheral surface 501 of the bent portion 56 and the inner peripheral surface 501 of the boss portion-side portion 57. The point N corresponds to a boundary line between the inner peripheral surface 501 of the boss portion-side portion 57 and the outer peripheral surface 301 of the piston pin boss portion 3. The outer peripheral surface 500 and the inner peripheral surface 501 of the boss portion-side portion 57 are substantially in parallel with each other. A distance from the third axis 63 to the outer peripheral surface 500 of the boss portion-side portion 57 in the second axial direction is increasing from the point G toward the point E (according to an increase in the distance from the second axis 62). A distance from the third axis 63 to the inner peripheral surface 501 of the boss portion-side portion 57 in the second axial direction (a distance between the boss portion-side portion 57 and the third axis 63) is increasing from the point N toward the point L (according to an increase in the distance from the second axis 62). A point F on the outer peripheral surface 500 of the boss portion-side portion 57 is an intersection point between a perpendicular line drawn from the point L toward the outer peripheral surface 500, and the outer peripheral surface 500. A point M on the inner peripheral surface 501 of the boss portion-side portion 57 is an intersection point between a perpendicular line drawn from the point G toward the inner peripheral surface 501, and the inner peripheral surface 501. The end portion 571 is a right triangle range surrounded by the point L, the point F, and the point E. A line segment connecting the point L and the point E to each other corresponds to a boundary surface between the bent portion 56 and the boss portion-side portion 57 (the end portion 571). The end portion 572 is a generally right triangle range surrounded by the point G, the point M, and the point N. A line segment connecting the point G and the point N to each other corresponds to a boundary surface between the boss portion-side portion 57 (the end portion 572) and the piston pin boss portion 3. The end portion 572 is connected to around an intermediate position of the piston pin boss portion 3 in the second axial direction (slightly offset from the intermediate position toward the third axial direction side). A cross-sectional area of the piston pin boss portion 3 perpendicular to the second axis 62 is increasing from the end portions 302 and 303 in the second axial direction toward a connection portion between the piston pin boss portion 3 and the end portion 572 (the point G or the point N). A distance between the inner peripheral surface of the piston pin hole 300 and the outer peripheral surface 301 of the piston pin boss portion 3 (a thickness of the piston pin boss portion 3 around the piston pin hole 300) is increasing from the end portions 302 and 303 toward the above-described connection portion along the second axial direction.

Assume that O represents an intersection point between a line passing through an intermediate portion of the skirt portion-side portion 55 (the main body portion 550) in a thickness direction (a portion located equal distance away from both the outer peripheral surface 500 and the inner peripheral surface 501), and a line passing through an intermediate portion of the boss portion-side portion 57 (the main body portion 570) in the thickness direction. Assume that P represents an intersection point between a half line (an extension line of the skirt portion-side portion 55) 64 extending with an end point thereof placed at the point O and passing through the intermediate portion of the skirt portion-side portion 55 (the main body portion 550) in the thickness direction, and the third axis 63. Assume that Q represents an intersection point between a half line (an extension line of the boss portion-side portion 57) 65 extending with an end point thereof placed at the point O and passing through an intermediate portion of the boss portion-side portion 57 (the main body portion 570) in the thickness direction, and the third axis 63. Among interior angles of a triangle defined with vertexes thereof placed at the points O, P, and Q, θ1 is an acute angle among angles defined between the half line 64 and the third axis 63. Among angles defined between the half line 65 and the third axis 63, θ2 is an acute angle. Among angles defined with the point O serving as a vertex and both the half lines 64 and 65 serving as sides, θ3 is a minor angle. The angle θ1 is larger than θ2. The angle θ3 is an obtuse angle.

Assume that a half line 66 is a half line that is a tangential line at the point A on the outer peripheral surface 400 of the skirt portion 4 and extends with an end point thereof placed at the point A. Assume that θ4 represents a minor angle among angles defined between the half line 66 (the outer peripheral surface 400 of the skirt portion 4 approximated by the half line 66) and the outer peripheral surface 500 of the skirt portion-side portion 55. Assume that a half line 67 is a half line that is a tangential line at the point H on the inner peripheral surface 401 of the skirt portion 4 and extends with an end point thereof placed at the point H. Assume that θ5 represents a minor angle among angles defined between the half line 67 (the inner peripheral surface 401 of the skirt portion 4 approximated by the half line 67) and the inner peripheral surface 501 of the skirt portion-side portion 55. Both θ4 and θ5 correspond to the minor angles among the angles defined between the skirt portion-side portion 55 and the skirt portion 4, and are obtuse angles.

Assume that, at the piston pin boss portion 3, R represents an intersection point between the end portion 302 on one side farther away from the third axis 63 and the second axis 62, and S represents an intersection point between the end portion 303 on the other side closer to the third axis 63 and the second axis 62. Assume that T represents an intermediate point between the point R and the point S in the second axis 62 (a center of the piston pin boss portion 3 in the second axial direction). A distance from the third axis 63 to the point A is shorter than a distance from the third axis 63 to the point R and is slightly shorter than a distance from the third axis 63 to the point T in the second axial direction. In other words, a dimension (a width) of the skirt portion 4 in the circumferential direction of the piston (the second axial direction) is shorter than a distance between the point R of the first piston pin boss portion 31 and the point R of the second piston pin boss portion 32, and is slightly shorter than a distance between the point T of the first piston pin boss portion 31 and the point T of the second piston pin boss portion 32. The point T is located between the point G and the point N in the second axial direction. In the second axial direction, the point N is located closer to the third axis 63 than the point T is (the distance from the third axis 63 to the point N is shorter than the distance from the third axis 63 to the point T), and the point G is located farther away from the third axis 63 than the point T is (the distance from the third axis 63 to the point G is longer than the distance from the third axis 63 to the point T). Similarly, the point A is located between the point G and the point N in the second axial direction.

A distance from an approximate midpoint U of a line segment connecting the point A and the point H to each other (an intersection point between the half line 64 and the line segment AH) to a midpoint V of a line segment connecting the point C and the point J to each other (an intersection point between the half line 64 and the line segment JC) corresponds to a dimension of the skirt portion-side portion 55 in the circumferential direction of the piston 1. A distance from an approximate midpoint W of a line segment connecting the point E and the point L to each other (an intersection point between the half line 65 and the line segment EL) to a midpoint X of a line segment connecting the point G and the point N to each other (an intersection point between the half line 65 and the line segment GN) corresponds to a dimension of the boss portion-side portion 57 in the circumferential direction of the piston 1. The above-described distance from the point W to the point X is longer than the above-described distance from the point U to the point V. In other words, the boss portion-side portion 57 is larger in dimension in the circumferential direction (longer in the circumferential direction) than the skirt portion-side portion 55. Further, the distance from the point A to the point B (from the point I to the point J) corresponds to a dimension of the main body portion 550 of the skirt portion-side portion 55 in the circumferential direction of the piston 1. The distance from the point F to the point G (from the point L to the point M) corresponds to a dimension of the main body portion 570 of the boss portion-side portion 57 in the circumferential direction of the piston 1. The distance from the point F to the point G (from the point L to the point M) is longer than the distance from the point A to the point B (from the point I to the point J). In other words, the main body portion 570 of the boss portion-side portion 57 is larger in dimension in the circumferential direction (longer in the circumferential direction) than the main body portion 550 of the skirt portion-side portion 55.

A dimension of the skirt portion 4 in the radial direction around the first axis 61 (the distance between the outer peripheral surface 400 and the inner peripheral surface 401 of the skirt portion 4) will be referred tows a skirt portion thickness. A dimension of the skirt portico-side portion 55 in a direction perpendicular to the half line 64 will be referred to as a skirt portion-side portion first thickness. The skirt portion-side portion first thickness at the main body portion 550 is a distance between the outer peripheral surface 500 and the inner peripheral surface 501 of the skirt portion-side portion 55 in the direction perpendicular to the half line 64. An average value of the skirt portion-side portion first thickness at the end portion 551 can be approximated by a distance from the point U to the inner peripheral surface 501 in the direction perpendicular to the half line 64. A dimension of the skirt portion-side portion 55 in the second axial direction (the distance between the outer peripheral surface 500 and the inner peripheral surface 501 of the skirt portion-side portion 55) will be referred to as a skirt portion-side portion second thickness. A dimension of the bent portion 56 in a direction perpendicular to a direction in which the apron portion 5 extends in the circumferential direction of the piston 1 (a distance between the outer peripheral surface 500 and the inner peripheral surface 501 of the bent portion 56) will be referred to as a bent portion first thickness. The bent portion first thickness can be approximated by a distance between the outer peripheral surface 500 and the inner peripheral surface 501 on the line passing through the point O and the point D, a distance between the outer peripheral surface 500 and the inner peripheral surface 501 on the line passing through the point O and the point K, or a distance between the point D and the point K. A dimension of the bent portion 56 in the second axial direction (a distance between the outer peripheral surface 500 and the inner peripheral surface 501 of the bent portion 56) will be referred to as a bent portion second thickness. A dimension of the boss portion-side portion 57 in the direction perpendicular to the half line 65 will be referred to as a boss portion-side portion first thickness. The boss portion-side portion first thickness at the main body portion 570 is a distance between the outer peripheral surface 500 and the inner peripheral surface 501 of the boss portion-side portion 57 in the direction perpendicular to the half line 65. An average value of the boss portion-side portion first thickness at the end portion 572 can be approximated by a distance from the point X to the inner peripheral surface 501 in the direction perpendicular to the half line 65. A distance of the boss portion-side portion 57 in the second axial direction (a distance between the outer peripheral surface 500 and the inner peripheral surface 501 of the boss portion-side portion 57) will be referred to as a boss portion-side portion second thickness. The boss portion-side portion first thickness at the main body portion 570 of the boss portion-side portion 57 is greater than the skirt portion thickness. The skirt portion-side portion first thickness at the main body portion 550 of the skirt portion-side portion 55 is greater than the boss portion-side portion first thickness at the main body portion 570. The bent portion first thickness is greater than the skirt portion-side portion first thickness at the main body portion 550. The skirt portion-side portion first thickness at the end portion 551 of the skirt portion-side portion 55 (an average value thereof) is greater than the boss portion-side portion first thickness at the end portion 572 of the boss portion-side portion 57 (an average value thereof). The bent portion first thickness is greater than the skirt portion-side portion first thickness at the end portion 551 (an average value thereof). The bent portion second thickness is greater than the boss portion-side second thickness. The skirt portion-side portion second thickness is greater than the bent portion second thickness.

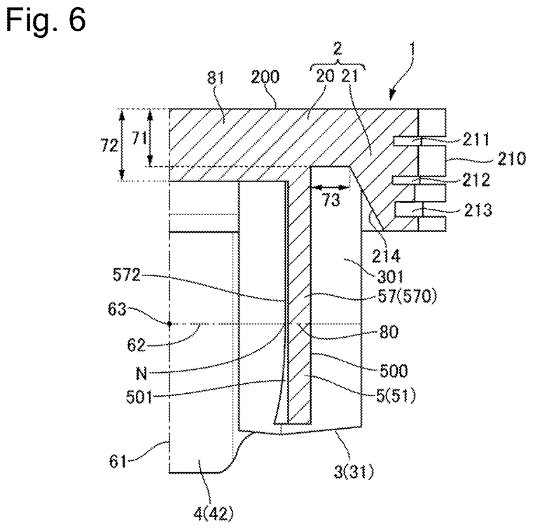

FIG. 6 illustrates a cross section 81 of the piston 1 perpendicular to the third axis 63. A dimension of the crown surface portion 20 of the piston head 2 in the first axial direction will be referred to as a piston head thickness. A piston head thickness 71 on an outer side in the radial direction of the piston 1 with respect to a connection portion between the apron portion 5 (the boss portion-side portion 57) and the piston head 2 (one side farther away from the first axis 61 or the third axis 63) is thinner than a piston head thickness 72 on an inner side in the radial direction of the piston 1 with respect to the above-described connection portion (the other side closer to the first axis 61 or the third axis 63).

Next, advantageous effects will be described. When the engine 100 is activated, the piston 1 reciprocates inside the cylinder 108 by receiving a combustion pressure generated in the combustion chamber 105 during an expansion stroke with the piston crown surface 200. This reciprocating movement is converted into a rotational movement by the connecting rod 104, and is output to the crankshaft. The combustion pressure is applied to around the central portion of the piston head 2 (a predetermined range around the first axis), and a reaction force is also applied thereto from the piston pin 109 via the piston pin boss portions 3. The piston rings 221 to 223 and the skirt portions 4 slidably move relative to the inner peripheral side of the cylinder liner 102 (the inner wall of the cylinder 108). Each of the skirt portions 4 is pressed against the inner wall of the cylinder 108. The first skirt portion 41 is located on a thrust side with respect to the second axis 62, and the second skirt portion 42 is located on an opposite thrust side with respect to the second axis 62. In many engines, especially immediately after a top dead center, the first skirt portion 41 (on the thrust side) is pressed against the inner wall of the cylinder 108 by a stronger force than the second skirt portion 42 (on the opposite thrust side) due to the combustion pressure in the combustion chamber 105. Each of the skirt portions 4 includes the portion protruding and extending beyond each of the apron portions 5 to the other side in the first axial direction. Therefore, the skirt portion 4 can further effectively suppress an oscillation operation of the piston 1 in the direction around the piston pin 109, and a weight of the piston 1 can also be reduced due to the lightening of the apron portion 5.

The piston head thickness is thinner on the outer side than on the inner side of each of the apron portions 5 (the connection portion between the apron portions 5 and the piston head 2) in the radial direction around the first axis 61. The weight of the piston 1 can be reduced due to the reduction in the piston head thickness 71 (reduces the piston head thickness 71 by a larger amount) on the outer side of the apron portion 5 in the radial direction in this manner. On the other hand, stiffness around the central portion of the piston head 2 can be improved by increasing the piston head thickness 72 on the inner side of the apron portion 5 in the radial direction. As a result, a deformation amount can be reduced around the central portion of the piston head 2 (subjected to the combustion pressure and the reaction force from the piston pin 109).

The distance between the boss portion-side portion 57 of each of the apron portions 5 and the third axis 63 increases according to the increase in the distance from the second axis 62 in the cross section 80 perpendicular to the first axis 61. In other words, according to the reduction in the distance from the second axis 62, the distance between each of the boss portion-side portions 57 and the third axis 63 reduces, and the distance between the boss portion-side portions 57 opposed to across the third axis 63 in the second axial direction reduces. Therefore, each of the boss portion-side portions 57 is connected to the crown surface portion 20 at a further closer position to the central portion of the piston head 2. Each of these boss portion-side portions 57 reinforces the piston head 2 (the crown surface portion 20) by functioning as a so-called rib. Due to this reinforcement, the deformation amount can be further reduced around the central portion of the piston head 2. Further, the distance from the above-described connection portion to the land portion 21 (the inner peripheral surface 214 thereof) increases as much as the approach of the connection portion between each of the boss portion-side portions 57 and the crown surface portion 20 to the central portion of the piston head 2. This can lead to expansion of the above-described region located on the outer side of the apron portion 5 in the radial direction and having the thin piston head thickness 71. As a result, the weight of the piston 1 can be further reduced.

In the cross section 80, the portion (the point N) closest to the third axis 63 in the end portion 572 of each of the boss portion-side portions 57 on the piston pin boss portion 3 side is closer to the third axis 63 than the central portion (the point T) of each of the piston pin boss portions 3 in the second axial direction. Due to this configuration, the distance between the boss portion-side portions 57 opposed to across the third axis 63 from each other in the second axial direction can be sufficiently reduced around the central portion of the piston head 2. Therefore, the deformation amount can be further reduced around the central portion of the piston head 2.

Each of the apron portions 5 includes the skirt portion-side portion 55 bent with respect to the skirt portion 4 inward in the radial direction of the piston 1. Therefore, a width of each of the skirt portions 4 (the outer peripheral surface 400) in the circumferential direction of the piston 1 is reduced by an amount corresponding to the skirt portion-side portion 55, which means a reduction in a sliding area between the inner wall of the cylinder 108 and each of the skirt portions 4. This results in a reduction in sliding resistance at each of the skirt portions 4, and therefore can improve fuel efficiency. Then, a displacement of the skirt portion 4 when the skirt portion 4 is pressed against the inner wall of the cylinder 108 can be absorbed by deflection of the skirt portion-side portion 55. In other words, the provision of the skirt portion-side portion 55 can reduce the width of the skirt portion 4 in the circumferential direction while ensuring strength of the piston 1. Further, the provision of the skirt portion-side portion 55 leads to an increase in an angle at the boundary portion between the boss portion-side portion 57 and the skirt portion 4 side, thereby contributing to easing stress concentration on the above-described boundary portion, compared to when the boss portion-side portion 57 is directly connected to the skirt portion 4.

In the cross section 80, the dimension of each of the skirt portions 4 in the second axial direction is shorter than a distance in the second axial direction between the end portion 302 (the point R) of the first piston pin boss portion 31 on the one side thereof farther away from the third axis 63 and the end portion 302 (the point R) of the second piston pin boss portion 32 on the one side thereof farther away from the third axis 63. The sliding area between the inner wall of the cylinder 108 and each of the skirt portions 4 can be sufficiently reduced by setting the width of each of the skirt portions 4 in the circumferential direction of the piston 1 to the narrower width than the distance between the end portions 302 of both the piston pin boss portions 3 on the outer side in the radial direction in this manner. Similarly, the width of each of the skirt portions 4 in the circumferential direction of the piton 1 is narrower than the distance between the midpoints T of both the piston pin boss portions 3 in the second axial direction. Therefore, the above-described sliding area can be further effectively reduced.

In the cross section 80, the dimension of the boss portion-side portion 57 from the bent portion 56 of each of the skirt portions 5 to the piston pin boss portion 3 (the distance from the point W to the point X) is larger than the dimension of the skirt portion-side portion 55 from the skirt portion 4 to the bent portion 56 (the distance from the point U to the point V). In other words, the boss portion-side portion 57 is larger in dimension in the circumferential direction than the skirt portion-side portion 55. This configuration can expand, in the second axial direction, the above-described region in which the distance between the boss portion-side portions 57 opposed to across the third axis 63 from each other in the second axial direction is reduced. Due to this configuration, the distance between the boss portion-side portions 57 opposed to across the third axis 63 from each other in the second axial direction can be sufficiently reduced around the central portion of the piston head 2. Therefore, the deformation amount can be further reduced around the central portion of the piston head 2. This can lead to expansion of the above-described region located on the outer side of the apron portion 5 in the radial direction and having the thin piston head thickness 71. As a result, the weight of the piston 1 can be further reduced. In the cross section 80, the dimension of the main body portion 570 of the boss portion-side portion 57 in the circumferential direction (the distance from the point F to the point G) is larger than the dimension of the main body portion 550 of the skirt portion-side portion 55 in the circumferential direction (the distance from the point A to the point B). Therefore, advantageous effects the same as above can be acquired.

In the cross section 80 of each of the apron portions 5, the minor angle (θ4 or θ5) among the angles defined between the skirt portion-side portion 55 and the skirt portion 4 is an obtuse angle. Therefore, the stress concentration can be eased at the boundary portion between the skirt portion 4 and the skirt portion-side portion 55 when the skirt portion 4 is pressed against the inner wall of the cylinder 108. In the cross section 80, the acute angle θ1 among the angles defined between the extension line of the skirt portion-side portion 55 (the half line 64) and the third axis 63 is larger than the acute angle θ2 among the angles defined between the extension line of the boss portion-side portion (the half line 65) and the third axis 63. In this manner, the stress concentration can be further eased at the above-described boundary portion by setting a relatively large angle as the inclination angle θ1 of the skirt portion-side portion 55 with respect to the third axis 63. The minor angle (θ3) among the angles defined between the skirt portion-side portion 55 and the boss portion-side portion 57 is the obtuse angle. Therefore, the stress concentration can be eased at the boundary portion (the bent portion 56) between the skirt portion-side portion 55 and the boss portion-side portion 57 when the skirt portion 4 is pressed against the inner wall of the cylinder 108.

In the cross section 80 of each of the apron portions 5, the boss portion-side portion second thickness, which is the dimension of the boss portion-side portion 57 in the second axial direction, is thinner than the skirt portion-side portion second thickness, which is the dimension of the skirt portion-side portion 55 in the second axial direction. Therefore, a cross section perpendicular to the compression force applied in the third axial direction inside the apron portion 5 when the skirt portion 4 is pressed against the inner wall of the cylinder 108 is larger at the skirt portion-side portion 55 than at the boss portion-side portion 57. Therefore, a compression stress can be reduced on the skirt portion-side portion 55 side located closer to the skirt portion 4 in the third axial direction and easily subjected to a further strong compression force. As a result, strength balance can be improved in the entire apron portion 5.

Further, assuming that the thickness direction refers to the direction perpendicular to the direction in which the apron portion 5 extends from the skirt portion 4 toward the piston pin boss portion 3 in the cross section 80 of each of the apron portions 5 (a direction normal to the outer peripheral surface 500 or the inner peripheral surface 501 in the cross section 80), the boss portion-side portion first thickness, which is the dimension of the boss portion-side portion 57 in the thickness direction, is thinner than the skirt portion-side portion first thickness, which is the dimension of the skirt portion-side portion 55 in the thickness direction. Therefore, the boss portion-side portion 57 is more easily deflected in the thickness direction than the skirt portion-side portion 55 is. Now, the dimension of the boss portion-side portion 57 (the distance from the point W to the point X) is larger than the dimension of the skirt portion-side portion 55 (the distance from the point U to the point V) in the circumferential direction of the piston 1. Therefore, the boss portion-side portion 57 is further easily deflected in the thickness direction. More specifically, the boss portion-side portion 57 is further efficiently deflected because the boss portion-side portion 57, which is longer in the circumferential direction than the skirt portion-side portion 55, has the thinner first thickness than the first thickness of the skirt portion-side portion 55. Due to this configuration, the displacement of the skirt portion 4 can be efficiently absorbed by the deflection of the boss portion-side portion 57 when the skirt portion 4 is pressed against the inner wall of the cylinder 108. Therefore, the stress concentration can be further eased at the boundary portion between the skirt portion 4 and the skirt portion-side portion 55 and at the bent portion 56.

In the cross section 80, the dimension in the second axial direction at the boundary portion between the skirt portion-side portion 55 of each of the apron portions 5 and the skirt portion 4 (the line segment connecting the point A and the point H to each other and the vicinity thereof) (which is substantially the skirt portion-side portion second thickness) is greater than the bent portion second thickness, which is the dimension of the bent portion 56 in the second axial direction. Therefore, the cross section perpendicular to the compression force applied in the third axial direction inside the apron portion 5 when the skirt portion 4 is pressed against the inner wall of the cylinder 108 is larger at the above-described boundary portion between the skirt portion-side portion 55 and the skirt portion 4 than at the bent portion 56. Therefore, the compression stress can be reduced on the above-described boundary portion side, which is located closer to the skirt portion 4 in the third axial direction than the bent portion 56 is and easily subjected to a further strong compression force. As a result, the strength balance can be improved in the entire apron portion 5. Similarly, the bent portion second thickness is greater than the dimension of the boundary portion between the boss portion-side portion 57 and the piston pin boss portion 3 (the line segment connecting the point G and the point N to each other and the vicinity thereof) in the second axial direction (which is substantially the boss portion-side portion second thickness). Therefore, the compression stress can be reduced on the bent portion 56 side, which is located closer to the skirt portion 4 in the third axial direction than the above-described boundary portion between the boss portion-side portion 57 and the piston pin boss portion 3 is and easily subjected to a further strong compression force.

Further, in the cross section 80, the dimension of the bent portion 56 of each of the apron portions 5 in the thickness direction (the bent portion first thickness) is larger than the dimension of the end portion 551 of the skirt portion-side portion 55 on the skirt portion 4 side in the thickness direction (the average value of the skirt portion-side portion first thickness) and the dimension of the end portion 572 of the boss portion-side portion 57 on the piston pin boss portion 3 side in the thickness direction (the average value of the boss portion-side portion first thickness). Therefore, a cross section along a shearing force applied in the thickness direction inside the apron portion 5 when the skirt portion 4 is pressed against the inner wall of the cylinder 108 is larger at the bent portion 56 than at the end portion 551 of the skirt portion-side portion 55 and the end portion 572 of the boss portion-side portion 57. Therefore, an average shearing stress can be reduced on the bent portion 56 side easily subjected to a stronger shearing force than at the end portion 551 and the end portion 572. As a result, the strength balance can be improved in the entire apron portion 5. Similarly, the dimension of the end portion 551 of the skirt portion-side portion 55 in the thickness direction (the average value of the skirt portion-side portion first thickness) is larger than the dimension of the end portion 572 of the boss portion-side portion 57 in the thickness direction (the average value of the boss portion-side portion first thickness). Therefore, the average shearing stress can be reduced on the end portion 551 side easily subjected to a stronger shearing force than at the end portion 572.

Each of the above-described relationships does not have to be established at all the portions of the apron portion 5 in the first axial direction, and each of the above-described advantageous effects can be achieved as long as each of the above-described relationships is established on at least a part thereof. In the present embodiment, each of the above-described relationships is established in the cross section 80 passing through the second axis 62 of each of the apron portions 5 and extending perpendicularly to the first axis 61. The plane passing through the second axis 62 located at the center of the piston pin 109 (the piston pin hole 300) is an approximately intermediate portion of the apron portion 5 in the first axial direction. Therefore, each of the above-described advantageous effects can be achieved in a balanced manner in the entire apron portion 5. For example, the acute angle θ1 is larger than the acute angle θ2 in the cross section 80 passing through the second axis 62 of each of the apron portions 5 and extending perpendicularly to the first axis 61. Therefore, the stress concentration can be further eased at the boundary portion between the skirt portion 4 and the skirt portion-side portion 55 in a balanced manner in the entire apron portion 5. Further, in the present embodiment, each of the above-described relationships is established in the cross section passing through the connection portion between each of the apron portions 5 with the piston head 2 and extending perpendicularly to the first axis 61. Therefore, the above-described advantageous effects can be further reliably acquired. For example, the dimension of the boss portion-side portion 57 in the circumferential direction (the distance from the point W to the point X) is larger than the dimension of the skirt portion-side portion 55 in the circumferential direction (the distance from the point U to the point V) in the cross section passing through the connection portion of each of the apron portions 5 with the piston head 2 and extending perpendicularly to the first axis 61. Therefore, it can be further ensured that the distance between the boss portion-side portions 57 connected to the piston head 2 in the second axial direction is sufficiently reduced around the central portion of the piston head 2. Further, in the present embodiment, each of the above-described relationships is established in the cross section perpendicular to the first axis 61 in the entire apron portion 5 in the first axial direction. Therefore, each of the above-described advantageous effects can be effectively achieved in the entire apron portion 5.

### Second Embodiment

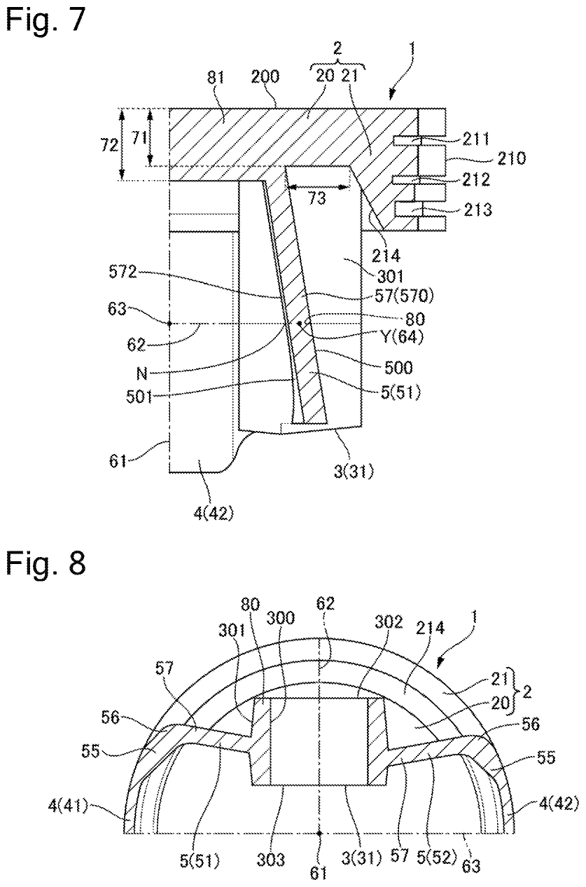

First, a configuration will be described. In the following description, a second embodiment will be described assigning the same reference numerals as the first embodiment to members and structures shared with the first embodiment and omitting descriptions thereof. As illustrated in FIG. 7, the end portion 572 of the boss portion-side portion 57 of the apron portion 5 is connected to the same position of the piston pin boss portion 3 as the first embodiment in the second axial direction in the cross section 80. In the cross section 81, the boss portion-side portion 57 (the main body portion 570 thereof) is rotated around the point Y on the half line 64 in the cross section 80 (tilted with respect to the first axis 61) so as to be positioned closer to the first axis 61 on one side in the first axial direction with respect to the cross section 80 and positioned farther away from the first axis 61 on the other side in the first axial direction with respect to the cross section 80. The distance between the boss portion-side portions 57 opposed to across the third axis 63 from each other in the second axial direction (the distance between the boss portion-side portion 57 of the first apron portion 51 and the boss portion-side portion 57 of the third apron portion 53 in the second axial direction, and the distance between the boss portion-side portion 57 of the second apron portion 52 and the boss portion-side portion 57 of the fourth apron portion 54 in the second axial direction) is gradually reducing from the other side toward the one side in the first axial direction. A distance 73 from the connection portion between the boss portion-side portion 57 (the main body portion 570 thereof) and the piston head 2 to the land portion 21 in the radial direction of the piston 2 (the second axial direction) is longer than in the first embodiment (refer to FIG. 6). The skirt portion-side portion 55 and the bent portion 56 extend in the first axial direction. The end portion 571 of each of the boss portion-side portions 57 is shaped like being twisted so as to connect the main body portion 570 of the boss portion-side portion 57 tilted as described above with respect to the first axis 61 and the bent portion 56 extending in the first axial direction to each other. Other configurations are similar to the first embodiment, such as the piston head thickness 71 thinner than the piston head thickness 72.

Next, advantageous effects will be described. The distance between the first apron portion 51 and the third apron portion 53 in the second axial direction, and the distance between the second apron portion 52 and the fourth apron portion 54 in the second axial direction are gradually reducing from the other side toward the one side of the first axis 61. Therefore, each of the boss portion-side portions 57 is connected to the crown surface portion 20 at a further closer position to the central portion of the piston head 2. Due to this configuration, the deformation amount can be further reduced around the central portion of the piston head 2. This can lead to an increase in the distance 73 and expansion of the above-described region located on the outer side of the apron portion 5 in the radial direction and having the thin piston head thickness 71. Therefore, the weight of the piston 1 can be further reduced. Other advantageous effects are similar to the first embodiment.

### Third Embodiment

First, a configuration will be described. In the following description, a third embodiment will be described assigning the same reference numerals as the first embodiment to members and structures shared with the first embodiment and omitting descriptions thereof. As illustrated in FIG. 8, in the cross section 80, the dimension of the skirt portion-side portion 55 of the second apron portion 52 (and the fourth apron portion 54) in the circumferential direction is smaller than the dimension of the skirt portion-side portion 55 of the first apron portion 51 (and the third apron portion 53) in the circumferential direction. The skirt portion-side portion 55 of the second apron portion 52 (and the fourth apron portion 54) substantially lacks the main body portion 550, and the end portions 551 and 552 are, so to speak, directly connected to each other. The dimension of the boss portion-side portion 57 of the second apron portion 52 (and the fourth apron portion 54) in the circumferential direction is larger than the dimension of the boss portion-side portion 57 of the first apron portion 51 (and the third apron portion 53) in the circumferential direction. The boss portion-side portion 57 of the second apron portion 52 (and the fourth apron portion 54) is connected to the piston pin boss portion 3 at a position closer to the third axis 63 than the boss portion-side portion 57 of the first apron portion 51 (and the third apron portion 53) is. The average value of the dimension (the thickness) of the first apron portion 51 in the second axial direction is larger than the average value of the dimension (the thickness) of the second apron portion 52 in the second axial direction. The above-described average value of the thickness of the apron portion 5 refers to a value resulting from dividing a value acquired by integrating the above-described thickness in the third axial direction (in other words, a cross-sectional area of this apron portion 5) by the dimension of this apron portion 5 in the third axial direction. Similarly, the average value of the thickness of the third apron portion 53 is larger than the average value of the thickness of the fourth apron portion 54. Other configurations are similar to the first embodiment.

Next, advantageous effects will be described. The first apron portion 51 and the third apron portion 53 support the first skirt portion 41. The second apron portion 52 and the fourth apron portion 54 support the second skirt portion 42. The first skirt portion 41 is located on the thrust side, and the second skirt portion 42 is located on the opposite thrust side. In many engines, the skirt portion on the thrust side is pressed against the inner wall of the cylinder 108 by a stronger force. On the other hand, the strength of the piston 1 can be improved by increasing the average value of the thickness of the apron portion 5, and the weight of the piston 1 can be reduced by reducing the average value of the thickness of the apron portion 5. In the present embodiment, the average value of the thickness of the first apron portion 51 and the third apron portion 53 supporting the first skirt portion 41 on the thrust side is larger than the average value of the thickness of the second apron portion 52 and the fourth apron portion 54 supporting the second skirt portion 42 on the opposite thrust side. Therefore, the weight can be reduced while the strength of the piston 1 can be improved. In other words, the balance can be improved between the retention of the strength of the piston 1 and the reduction in the weight. Other advantageous effects are similar to the first embodiment.

The boss portion-side portion 57 (the main body portion 570) of each of the apron portions 5 may be tilted with respect to the first axis 61 similarly to the second embodiment. Further, the thickness of the skirt portion-side portion 55 or the boss portion-side portion 57 itself may be reduced instead of or along with reducing the dimension of the skirt portion-side portion 55 of the second apron portion 52 (the fourth apron portion 54) in the circumferential direction and increasing the dimension of the boss portion-side portion 57 in the circumferential direction to make the average value of the thickness of the first apron portion 51 (the third apron portion 53) larger than the second apron portion 52 (the fourth apron portion 54). In the present embodiment, the connection portion between the boss portion-side portion 57 and the piston pin boss portion 3 is positioned further close to the third axis 63, since the dimension of the skirt portion-side portion 55 in the circumferential direction is small and the dimension of the boss portion-side portion 57 in the circumferential direction is large at the second apron portion 52 (the fourth apron portion 54). Therefore, the deformation amount can be further reduced around the central portion of the piston head 2, and the weight of the piston 1 can be further reduced.

### Other Embodiments

Having described the embodiments for implementing the present invention with reference to the drawings, the specific configuration of the present invention is not limited to the embodiments, and the present invention also includes a design modification and the like thereof made within a range that does not depart from the spirit of the present invention, if any. Further, the individual components described in the claims and the specification can be arbitrarily combined or omitted within a range that allows them to remain capable of achieving at least a part of the above-described objects or producing at least a part of the above-described advantageous effects. For example, the type of the engine may be any type. The engine is not limited to the four-stroke engine, and may be a two-stroke engine. The engine is not limited to the spark-ignition engine (the gasoline engine), and may be a compression ignition engine (a diesel engine). The method for supplying the fuel may be a direct injection method, which directly injects the fuel into the cylinder (the combustion chamber), or may be a port injection method, which injects the fuel into an intake port. The engine may be an engine mounted on a ship or the like without being limited to the engine mounted on the vehicle. The type of the piston may be any type. For example, the second axis 62 may be slightly offset from the first axis 61 toward the thrust side in the third axial direction to, for example, prevent so-called slap noise. Further, a recessed portion or the like may be provided on the piston crown surface to prevent interference with the valve.

[Technical Ideas Recognizable from Embodiments]

In the following description, other configurations recognizable from the above-described embodiments will be described.

(1) A piston of an internal combustion engine, in one configuration thereof, includes a piston head including a piston crown surface facing a combustion chamber, a pair of cylindrical piston pin boss portions positioned on an opposite side of the piston head with respect to the piston crown surface and each including a piston pin hole into which a piston pin is inserted, a pair of skirt portions positioned on an opposite side of the piston head with respect to the piston crown surface and positioned on both sides of the pair of piston pin boss portions in a direction of a third axis, and four apron portions connecting the pair of piston pin boss portions and the pair of skirt portions in the direction of the third axis and including a first apron portion, a second apron portion, a third apron portion, and a fourth apron portion. The first apron portion connects a first piston pin boss portion included in the pair of piston pin boss portions and a first skirt portion included the pair of skirt portions. The second apron portion connects the first piston pin boss portion and a second skirt portion included in the pair of skirt portions. The third apron portion connects a second piston pin boss portion included in the pair of piston pin boss portions and the first skirt portion. The fourth apron portion connects the second piston pin boss portion and the second skirt portion. The third axis is perpendicular to both a first axis and a second axis. The first axis extends along a movement direction of the piston in a cylinder of the internal combustion engine and passes through a center of a cross section of the piston head that extends perpendicularly to the movement direction of the piston. The second axis extends along a longitudinal direction of the piston pin hole and passes through a center of a cross section of the piston pin hole that extends perpendicularly to the longitudinal direction of the piston pine hole. Each of the four apron portions includes a bent portion, a boss portion-side portion positioned on one side where the pair of piston pin boss portions is located with respect to the bent portion, and a skirt portion-side portion positioned on an opposite side from the pair of piston pin boss portions with respect to the bent portion. In a cross section perpendicular to the first axis, a minor angle among angles defined by each of the skirt portion-side portions and each of the skirt portions included in the pair of skirt portions that are located adjacent to each of the skirt portion-side portions is an obtuse angle, and a distance between each of the boss portion-side portions and the third axis is increasing according to an increase in a distance from the second axis.
(2) According to a further preferable configuration, in the above-described configuration, in the cross section perpendicular to the first axis, a dimension of each of the skirt portions in a direction of the second axis is shorter than a distance in the direction of the second axis between an end portion of the first piston pin boss portion on one side thereof farther away from the third axis and an end portion of the second piston pin boss portion on one side thereof farther away from the third axis.
(3) According to another preferable configuration, in any of the above-described configurations, in the cross section perpendicular to the first axis, a portion closest to the third axis in an end portion of each of the boss portion-side portions on a piston pin boss portion side where the piston pin boss portion is located is closer to the third axis than a central portion of each of the piston pin boss portions in the direction of the second axis is to the third axis.
(4) According to further another preferable configuration, in any of the above-described configurations, a distance between the boss portion-side portion of the first apron portion and the boss portion-side portion of the third apron portion in the direction of the second axis and a distance between the boss portion-side portion of the second apron portion and the boss portion-side portion of the fourth apron portion in the direction of the second axis are gradually reducing from one side of the piston head on which the piston pin hole is located toward the other side of the piston head on which the piston crown surface is located in a direction of the first axis.
(5) According to further another preferable configuration, in any of the above-described configurations, a dimension of the piston head in the direction of the first axis is smaller on an outer side of each of the apron portions than on an inner side of each of these apron portions in a radial direction around the first axis.
(6) According to further another preferable configuration, in any of the above-described configurations, in a cross section of each of the apron portions that extends perpendicular to the first axis, a dimension of the boss portion-side portion from the bent portion to the piston pin boss portion is larger than a dimension of the skirt portion-side portion from the skirt portion to the bent portion.
(7) According to further another preferable configuration, in any of the above-described configurations, in a cross section of each of the apron portions that passes through the second axis and extends perpendicularly to the first axis, the dimension of the boss portion-side portion from the bent portion to the piston pin boss portion is larger than the dimension of the skirt portion-side portion from the skirt portion to the bent portion.
(8) According to further another preferable configuration, in any of the above-described configurations, in the cross section of each of the apron portions that extends perpendicular to the first axis, a thickness of the boss portion-side portion in the direction of the second axis is thinner than a thickness of the skirt portion-side portion in the direction of the second axis.
(9) According to further another preferable configuration, in any of the above-described configurations, in the cross section of each of the apron portions that extends perpendicular to the first axis, an acute angle among angles defined between an extension line of the skirt portion-side portion and the third axis is larger than an acute angle among angles defined between an extension line of the boss portion-side portion and the third axis.
(10) According to further another preferable configuration, in any of the above-described configurations, in the cross section of each of the apron portions that passes through the second axis and extends perpendicularly to the first axis, the acute angle among the angles defined between the extension line of the skirt portion-side portion and the third axis is larger than the acute angle among the angles defined between the extension line of the boss portion-side portion and the third axis.
(11) According to further another preferable configuration, in any of the above-described configurations, in the cross section of each of the apron portions that extends perpendicular to the first axis, a dimension of the bent portion is larger than a dimension of an end portion of the skirt portion-side portion on a skirt portion side where the skirt portion is located and a dimension of the end portion of the boss portion-side portion on the piston pin boss portion side where the piston pin boss portion is located in a thickness direction perpendicular to a direction in which the apron portion extends from the skirt portion toward the piston pin boss portion.
(12) According to further another preferable configuration, in any of the above-described configurations, in the cross section of each of the apron portions that extends perpendicular to the first axis, the dimension of the end portion of the skirt portion-side portion on the skirt portion side in the thickness direction is larger than the dimension of the end portion of the boss portion-side portion on the piston pin boss portion side in the thickness direction.
(13) According to further another preferable configuration, in any of the above-described configurations, a force with which the first skirt portion is pressed against the cylinder due to a combustion pressure in the combustion chamber is stronger than a force with which the second skirt portion is pressed against the cylinder due to the combustion pressure. In the cross section perpendicular to the first axis, an average value of dimensions of the first apron portion and the third apron portion in the direction of the second axis is larger than an average value of dimensions of the second apron portion and the fourth apron portion in the direction of the second axis.
(14) According to further another preferable configuration, in any of the above-described configurations, the first skirt portion is located on a thrust side with respect to the second axis, and the second skirt portion is located on an opposite thrust side with respect to the second axis.

The present application claims priority under the Paris Convention to Japanese Patent Application No. 2017-103296 filed on May 25, 2017. The entire disclosure of Japanese Patent Application No. 2017-103296 filed on May 25, 2017 including the specification, the claims, the drawings, and the abstract is incorporated herein by reference in its entirety.

### REFERENCE SIGNS LIST

1 piston
2 piston head
200 piston crown surface
31 first piston pin boss portion
32 second piston pin boss portion
300 piston pin hole
41 first skirt portion
42 second skirt portion
51 first apron portion
52 second apron portion
53 third apron portion
54 fourth apron portion
55 skirt portion-side portion
56 bent portion
57 boss portion-side portion
61 first axis
62 second axis
63 third axis
100 engine (internal combustion engine)
105 combustion chamber
108 cylinder
109 piston pin

1. A piston of an internal combustion engine comprising:
a piston head including a piston crown surface facing a combustion chamber;
a pair of cylindrical piston pin boss portions positioned on an opposite side of the piston head with respect to the piston crown surface, the pair of cylindrical piston pin boss portions each including a piston pin hole into which a piston pin is inserted;
a pair of skirt portions positioned on an opposite side of the piston head with respect to the piston crown surface, the pair of skirt portions being positioned on both sides of the pair of piston pin boss portions in a direction of a third axis; and
four apron portions connecting the pair of piston pin boss portions and the pair of skirt portions in the direction of the third axis, the four apron portions including a first apron portion, a second apron portion, a third apron portion, and a fourth apron portion, the first apron portion connecting a first piston pin boss portion included in the pair of piston pin boss portions and a first skirt portion included in the pair of skirt portions, the second apron portion connecting the first piston pin boss portion and a second skirt portion included in the pair of skirt portions, the third apron portion connecting a second piston pin boss portion included in the pair of piston pin boss portions and the first skirt portion, the fourth apron portion connecting the second piston pin boss portion and the second skirt portion,
wherein the third axis is perpendicular to both a first axis and a second axis,
wherein the first axis extends along a movement direction of the piston in a cylinder of the internal combustion engine and passes through a center of a cross section of the piston head that extends perpendicularly to the movement direction of the piston,
wherein the second axis extends along a longitudinal direction of the piston pin hole and passes through a center of a cross section of the piston pin hole that extends perpendicularly to the longitudinal direction of the piston pine hole,
wherein each of the four apron portions includes a bent portion, a boss portion-side portion positioned on a piston pin boss portion pair side where the pair of piston pin boss portions is located with respect to the bent portion, and a skirt portion-side portion positioned on an opposite side from the pair of piston pin boss portions with respect to the bent portion, and
wherein, in a cross section perpendicular to the first axis, a minor angle among angles defined by each of the skirt portion-side portions and each of the skirt portions included in the pair of skirt portions that are located adjacent to each of the skirt portion-side portions is an obtuse angle, and a distance between each of the boss portion-side portions and the third axis is increasing according to an increase in a distance from the second axis.

2. The piston of the internal combustion engine according to claim 1, wherein, in the cross section perpendicular to the first axis, a dimension of each of the skirt portions in a direction of the second axis is shorter than a distance in the direction of the second axis between an end portion of the first piston pin boss portion on one side thereof farther away from the third axis and an end portion of the second piston pin boss portion on one side thereof farther away from the third axis.

3. The piston of the internal combustion engine according to claim 1, wherein, in the cross section perpendicular to the first axis, a portion closest to the third axis in an end portion of each of the boss portion-side portions on a piston pin boss portion side where the piston pin boss portion is located is closer to the third axis than a central portion of each of the piston pin boss portions in the direction of the second axis is to the third axis.

4. The piston of the internal combustion engine according to claim 3, wherein a distance between the boss portion-side portion of the first apron portion and the boss portion-side portion of the third apron portion in the direction of the second axis and a distance between the boss portion-side portion of the second apron portion and the boss portion-side portion of the fourth apron portion in the direction of the second axis are gradually reducing from a piston pin hole side of the piston head on which the piston pin hole is located toward a piston crown surface side of the piston head on which the piston crown surface is located in a direction of the first axis.

5. The piston of the internal combustion engine according to claim 4, wherein a dimension of the piston head in the direction of the first axis is smaller on an outer side of each of the apron portions than on an inner side of each of these apron portions in a radial direction around the first axis.

6. The piston of the internal combustion engine according to claim 1, wherein, in a cross section of each of the apron portions that extends perpendicular to the first axis, a dimension of the boss portion-side portion from the bent portion to the piston pin boss portion is larger than a dimension of the skirt portion-side portion from the skirt portion to the bent portion.

7. The piston of the internal combustion engine according to claim 6, wherein, in a cross section of each of the apron portions that passes through the second axis and extends perpendicularly to the first axis, the dimension of the boss portion-side portion from the bent portion to the piston pin boss portion is larger than the dimension of the skirt portion-side portion from the skirt portion to the bent portion.

8. The piston of the internal combustion engine according to claim 6, wherein, in the cross section of each of the apron portions that extends perpendicular to the first axis, a thickness of the boss portion-side portion in the direction of the second axis is thinner than a thickness of the skirt portion-side portion in the direction of the second axis.

9. The piston of the internal combustion engine according to claim 1, wherein, in a cross section of each of the apron portions that extends perpendicular to the first axis, an acute angle among angles defined between an extension line of the skirt portion-side portion and the third axis is larger than an acute angle among angles defined between an extension line of the boss portion-side portion and the third axis.

10. The piston of the internal combustion engine according to claim 9, wherein, in a cross section of each of the apron portions that passes through the second axis and extends perpendicularly to the first axis, the acute angle among the angles defined between the extension line of the skirt portion-side portion and the third axis is larger than the acute angle among the angles defined between the extension line of the boss portion-side portion and the third axis.

11. The piston of the internal combustion engine according to claim 1, wherein, in a cross section of each of the apron portions that extends perpendicular to the first axis, a dimension of the bent portion is larger than a dimension of an end portion of the skirt portion-side portion on a skirt portion side where the skirt portion is located and a dimension of an end portion of the boss portion-side portion on a piston pin boss portion side where the piston pin boss portion is located in a thickness direction perpendicular to a direction in which the apron portion extends from the skirt portion toward the piston pin boss portion.

12. The piston of the internal combustion engine according to claim 11, wherein, in the cross section of each of the apron portions that extends perpendicular to the first axis, the dimension of the end portion of the skirt portion-side portion on the skirt portion side in the thickness direction is larger than the dimension of the end portion of the boss portion-side portion on the piston pin boss portion side in the thickness direction.

13. The piston of the internal combustion engine according to claim 1, wherein a force with which the first skirt portion is pressed against the cylinder due to a combustion pressure in the combustion chamber is stronger than a force with which the second skirt portion is pressed against the cylinder due to the combustion pressure, and
wherein, in the cross section perpendicular to the first axis, an average value of dimensions of the first apron portion and the third apron portion in the direction of the second axis is larger than an average value of dimensions of the second apron portion and the fourth apron portion in the direction of the second axis.

14. The piston of the internal combustion engine according to claim 13, wherein the first skirt portion is located on a thrust side with respect to the second axis, and the second skirt portion is located on an opposite thrust side with respect to the second axis.
